(19) United States
(12) Patent Application Publication
(10) Pub. No.: US 2020/0047146 A1
(43) Pub. Date: Feb. 13, 2020

(54) HYDROXYALKYLATED POLYACRYLAMIDE SURFACE COATINGS FOR IN SITU SYNTHESIS OF DNA ARRAYS

(71) Applicant: CENTRILLON TECHNOLOGY HOLDINGS CORPORATION, Grand Cayman (KY)

(72) Inventor: Glenn MCGALL, Palo Alto, CA (US)

(21) Appl. No.: 16/492,693

(22) PCT Filed: Mar. 6, 2018
(86) PCT No.: PCT/US2018/021051

§ 371 Date: Sep. 10, 2019

Related U.S. Application Data
(60) Provisional application No. 62/472,666, filed on Mar. 17, 2017.

(51) Int. Cl. B01J 19/00

(52) U.S. Cl. CPC B01J 19/0046; B01J 2219/00675; B01J 2219/00711; B01J 2219/00497; B01J 2219/00596

(57) ABSTRACT

The present disclosure relates to processes for derivatizing a surface of a substrate with a covalently bonded thin film of hydroxalkylated poly(acrylamide) as a platform for the synthesis of a biomolecule array. These processes can also be used to prepare a surface of a substrate for an in situ solid-phase synthesis of biomolecule array.

### CROSS-REFERENCE

This application claims the benefit of U.S. Provisional Patent Application No. 62/472,666, filed on Mar. 17, 2017, which is entirely incorporated herein by reference.

### BACKGROUND

With the advance in DNA sequencing and DNA-based diagnosis/detection, the in situ synthesis of oligonucleotide probes on solid support in an array format becomes important. To facilitate the fabrication of DNA arrays on solid support, surface treatment methods have been developed to modify the solid support. For example, untreated surface may lack suitable functional groups that are reactive or accessible to probe molecules because of surface crowding or steric hindrance. In addition, after the probes are bonded to the surface of the solid support, the probes have to remain accessible to target molecules in biological sample for the essay to work. Sometimes steric hindrance may hamper target-probe interactions on the surface of the solid support.

One way of surface treatments when preparing an array of probes is to fabricate polymer coatings by surface initiated polymerization to form surface polymeric film which incorporates biomolecules later. For example, polymer brushes have been synthesized via controlled free radical polymerization methods to covalently attach polymers to the surface of substrates. M. Husseman et al., Macromolecules (1999) 32(5): 1424-31. However, the surfaces thus formed are hydrophobic, and thus are not suitable for DNA array fabrication and the eventual detection of target molecules.

### SUMMARY

An aspect of the present disclosure provides a solid support, comprising covalently surface-bonded polymers comprising a compound of Formula I:

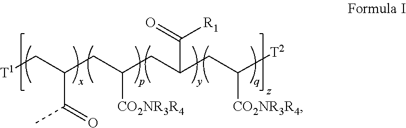

wherein R¹ is independently selected from the group comprising:

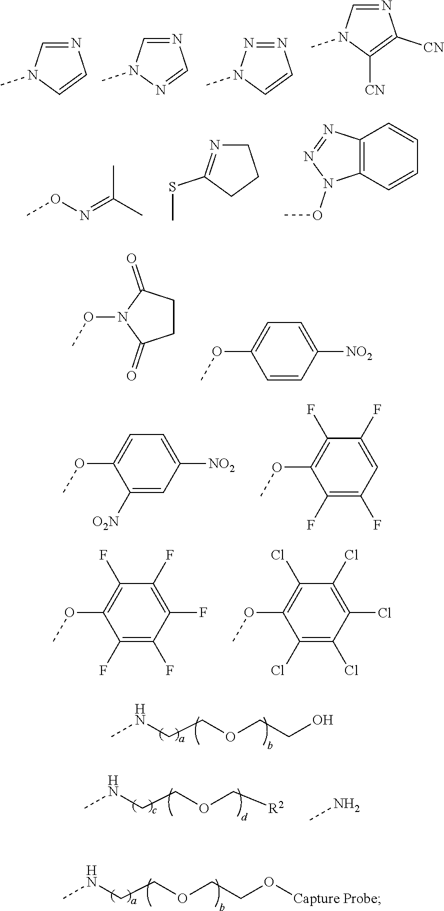

with the proviso that at least one R¹ is

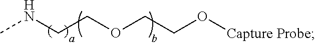

T¹ is absent, H, C₁-C₆ alkyl, or a first initiator residue;
T² is absent, H, C₁-C₆ alkyl or a second initiator residue;
R² is independently H, —CH₃, or —CH₂OCH₃;
R³ and R⁴, in each occurrence, are independently H or —CH₃;
Capture Probe comprises at least one molecule selected from the group consisting of
peptide, protein, glycosylated protein, glycoconjugate, aptomer, carbohydrate,
polynucleotide, oligonucleotide and polypeptide;
x is independently an integer from 1 to 20;
y is independently an integer from 1 to 20;
z is independently an integer from 2 to 200;
p is independently an integer from 0 to 20;
q is independently an integer from 0 to 20;
a is an integer from 1 to 5;
b is an integer from 0 to 10;
c is an integer from 1 to 5; and
d is an integer from 0 to 1.

In some embodiments of aspects provided herein, the solid support further comprises a surface comprising a plurality of amino groups covalently bonded to the surface, thereby allowing the compound of Formula I to covalently bond to at least a fraction of the plurality of the amino groups via an amide bond. In some embodiments of aspects provided herein, p is independently an integer from 1 to 20 and q is independently an integer from 1 to 20.

In some embodiments of aspects provided herein, R¹ is independently selected from the group consisting of:

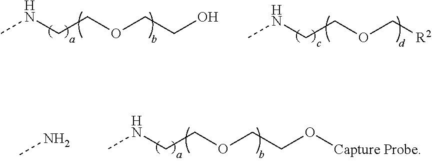

In some embodiments of aspects provided herein, the Capture Probe is an oligonucleotide. In some embodiments of aspects provided herein, the Capture Probe is DNA.

In some embodiments of aspects provided herein, the surface is glass or a polymeric substrate. In some embodiments of aspects provided herein, the polymeric substrate is at least one selected from the group consisting of an acrylnitrile-butadien-styrene, a cyclo-olefin-polymer, a cyclo-olefin copolymer, a polymethylene-methacrylate, a polycarbonate, a polystyrole, a polypropylene, a polyvinylchloride, a polyamide, a polyethylene, a polyethylene-terephthalate, a polytetrafluoro-ethylene, a polyoxymethylene, a thermoplastic elastomer, a thermoplastic polyurethane, a polyimide, a polyether-ether-ketone, a polylactic acid, and a polymethylpentene.

Another aspect of the present disclosure provides a solid support, comprising covalently surface-bonded polymers comprising a compound of Formula I:

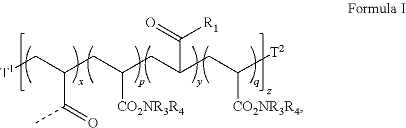

wherein R¹ is independently selected from the group consisting of:

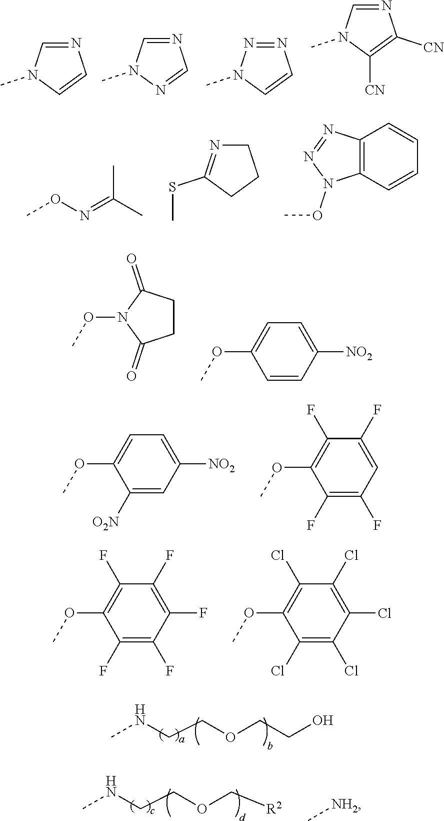

T¹ is absent, H, C₁-C₆ alkyl, or a first initiator residue;
T² is absent, H, C₁-C₆ alkyl or a second initiator residue;
R² is independently H, —CH₃, or —CH₂OCH₃;
R³ and R⁴, in each occurrence, are independently H or —CH₃;
x is independently an integer from 1 to 20;
y is independently an integer from 1 to 20;
z is independently an integer from 2 to 200;
p is independently an integer from 0 to 20;
q is independently an integer from 0 to 20;
a is an integer from 1 to 5;
b is an integer from 0 to 10;
c is an integer from 1 to 5; and
d is an integer from 0 to 10.

In some embodiments of aspects provided herein, the solid support further comprising a surface comprises a plurality of amino groups covalently bonded to the surface, thereby allowing the compound of Formula I to covalently bond to at least a fraction of the plurality of the amino groups via an amide bond.

In some embodiments of aspects provided herein, p is independently an integer from 1 to 20 and q is independently an integer from 1 to 20.

In some embodiments of aspects provided herein, R¹ is independently selected from the group consisting of:

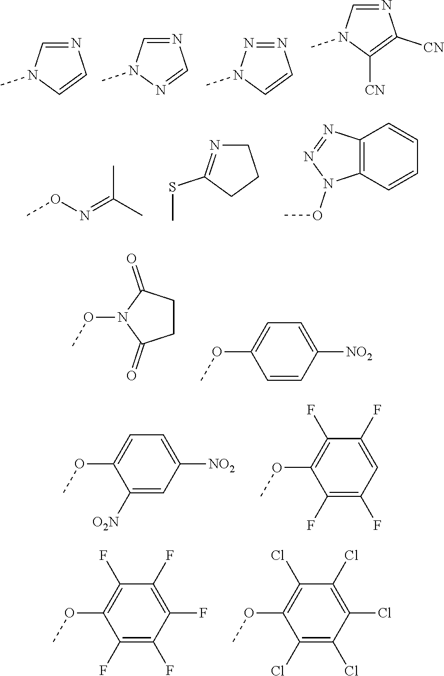

In some embodiments of aspects provided herein, R¹ is

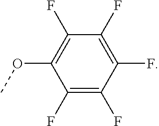

In some embodiments of aspects provided herein, R¹ is independently selected from the group consisting of:

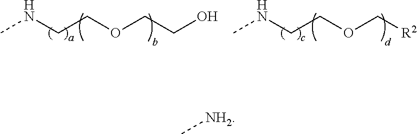

In some embodiments of aspects provided herein, the surface is glass or a polymeric substrate. In some embodiments of aspects provided herein, the polymeric substrate is at least one selected from the group consisting of an acrylnitrile-butadien-styrene, a cyclo-olefin-polymer, a cyclo-olefin copolymer, a polymethylene-methacrylate, a polycarbonate, a polystyrole, a polypropylene, a polyvinylchloride, a polyamide, a polyethylene, a polyethylene-terephthalate, a polytetrafluoro-ethylene, a polyoxymethylene, a thermoplastic elastomer, a thermoplastic polyurethane, a polyimide, a polyether-ether-ketone, a polylactic acid, and a polymethylpentene.

Another aspect of the present disclosure provides a method of derivatizing a surface of a substrate, comprising:

(a) providing a substrate having a surface comprising a plurality of first amino groups;

(b) reacting a first set of a plurality of reactive groups of a first reagent with a set of the plurality of the first amino groups, thereby forming a covalently surface-bonded film; and

(c) reacting a second set of the plurality of the reactive groups of the first reagent with a second reagent comprising a second amino group and a hydroxyalkyl-functionalized group, thereby forming a hydroxyalkylated surface-bonded film.

In some embodiments of aspects provided herein, the first amino group in (a) is a primary amine. In some embodiments of aspects provided herein, the method further comprises, prior to (a), treating the surface of the substrate with aminoalkyltrialkoxysilanes, ammonia plasma, or RF plasma deposition. In some embodiments of aspects provided herein, the first reagent in (b) is an amine-reactive acrylate polymer or an amine-reactive acrylate-co-acrylamide co-polymer.

In some embodiments of aspects provided herein, the amine-reactive acrylate polymer is a compound according to Formula II:

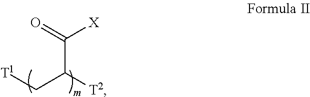

wherein X is an amine-reactive center independently selected from the group consisting of:

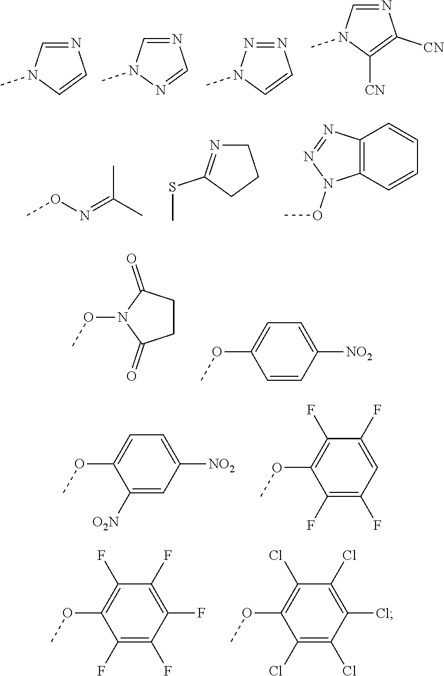

T¹ is absent, H, C₁-C₆ alkyl or a first initiator residue;

T² is absent, H, C₁-C₆ alkyl or a second initiator residue; and

m is an integer from 2 to 800.

In some embodiments of aspects provided herein, the acrylate-co-acrylamide co-polymer is a compound according to Formula III:

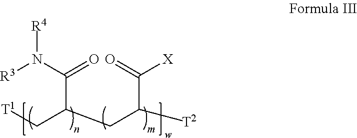

wherein X is an amine-reactive center, in each occurrence, independently selected from the group consisting of:

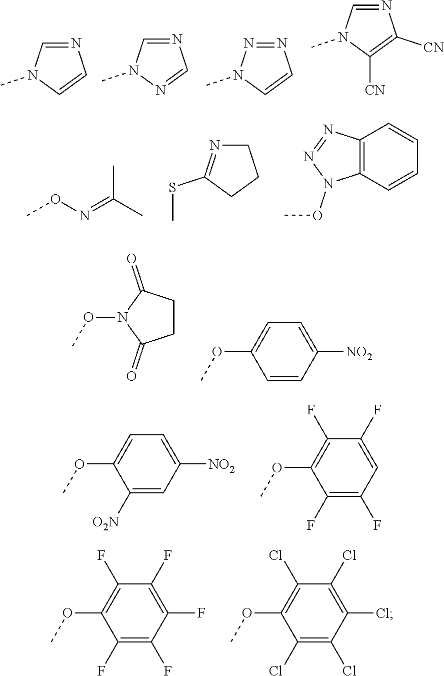

R³ and R⁴, in each occurrence, are independently H or —CH₃;
T¹ is absent, H, C₁-C₆ alkyl or a first initiator residue;
T² is absent, H, C₁-C₆ alkyl or a second initiator residue;
m is, in each occurrence, independently an integer from 1 to 20;
n is, in each occurrence, independently an integer from 1 to 20; and
w is an integer from 2 to 400.

In some embodiments of aspects provided herein, the reactive group is —C(O)X and X is independently selected from the group consisting of:

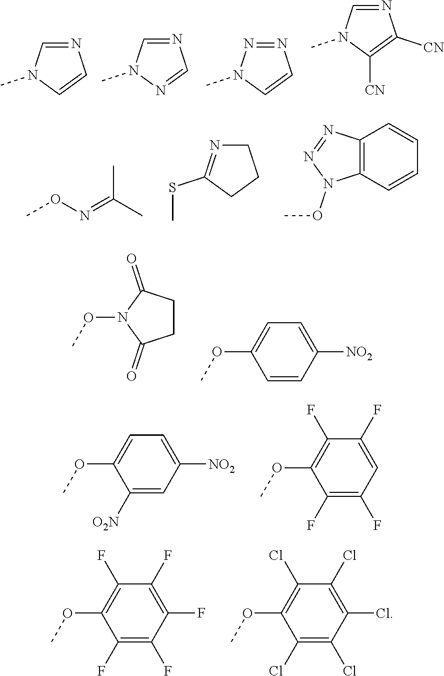

In some embodiments of aspects provided herein, the method further comprises in (c) reacting a third set of the plurality of the reactive groups with a third reagent comprising a third amino group, but not a hydroxyl group.

In some embodiments of aspects provided herein, the method further comprises (d) reacting the hydroxyalkylated surface-bonded film with a fourth reagent, thereby synthesizing an oligonucleotide array. In some embodiments of aspects provided herein, the synthesizing in (d) comprises inkjet synthesis or photolithographic synthesis. In some embodiments of aspects provided herein, the reacting in (d) comprises alkylation of the hydroxyalkyl group with an oligonucleotide reagent.

In some embodiments of aspects provided herein, the first reagent has a molecular weight of from about 5,000 to about 200,000.

Additional aspects and advantages of the present disclosure will become readily apparent to those skilled in this art from the following detailed description, wherein only illustrative embodiments of the present disclosure are shown and described. As will be realized, the present disclosure is capable of other and different embodiments, and its several details are capable of modifications in various obvious respects, all without departing from the disclosure. Accordingly, the drawings and description are to be regarded as illustrative in nature, and not as restrictive.

### INCORPORATION BY REFERENCE

All publications, patents, and patent applications mentioned in this specification are herein incorporated by reference to the same extent as if each individual publication, patent, or patent application was specifically and individually indicated to be incorporated by reference.

### BRIEF DESCRIPTION OF THE DRAWINGS

The novel features of the invention are set forth with particularity in the appended claims. A better understanding of the features and advantages of the present invention will be obtained by reference to the following detailed description that sets forth illustrative embodiments, in which the principles of the invention are utilized, and the accompanying drawings of which:

FIG. 1 shows exemplary embodiments of the solid support and preparation thereof according to the present disclosure;

FIG. 2A illustrates a hybridization image of a probe array in a checkerboard pattern, which was treated with a mixture of 1:1 ethylenediamine-water at room temperature for 7 hr;

FIG. 2B shows a graph of gray value vs. distance of the image shown in FIG. 2A;

FIG. 3A illustrates a hybridization image of a probe array in a checkerboard pattern, which was used as in FIG. 2A and was further treated with a mixture of aqueous 1:1 ammonia-methylamine at room temperature for 2 hr;

FIG. 3B shows a graph of gray value vs. distance of the image shown in FIG. 3A;

FIG. 4A illustrates a hybridization image of a probe array in a checkerboard pattern, which was used as in FIG. 3A and was further treated with a mixture of aqueous 1:1 ammonia-methylamine at 65° C. for 1 hr;

FIG. 4B shows a graph of gray value vs. distance of the image shown in FIG. 4A;

FIG. 5A illustrates a hybridization image of a probe array in a checkerboard pattern, which was used as in FIG. 4A and was further treated with a mixture of aqueous 1:1 ethylenediamine at 45° C. for 18 hr; and

FIG. 5B shows a graph of gray value vs. distance of the image shown in FIG. 5A.

### DETAILED DESCRIPTION

Because there is a need for a process to control surface density of probes on the support and provide access to target biological molecules for reactions with probes, the applicant experimented and discovered the subject matter for the present disclosure. The present disclosure provides a solid substrate for grafting and/or in situ solid-phase synthesis of probe arrays, including biomolecule arrays, for example, nucleic acid arrays. The surface of the solid substrate, as disclosed in the present disclosure, comprises a covalently bonded thin film of hydroxyalkylated poly(acrylamide), in-between the surface and the probes thereon. The present disclosure also provides several methods and processes of derivatizing a surface of a solid support to afford a covently bonded thin film of hydroxyalkylated poly(acrylamide), enabling in situ solid-phase synthesis of probe arrays on the thin film. The thin film of hydroxyalkylated poly(acrylamide) provides a platform for the synthesis of a biomolecule array, including a nucleic acid array, a polypeptide array, or an oligonucleotide array. The disclosed hydroxyalkylated poly(acrylamide) coating confers advantages of a controllable density of initiation/attachment sites for nucleic acid synthesis; compatibility with oligonucleotide synthesis chemistries and reaction conditions; reduced nonspecific binding with target nucleic acids; and hydrolytic stability in operation.

The term “oligonucleotide” as used herein refers to a nucleotide chain. In some cases, an oligonucleotide is less than 200 residues long, e.g., between 15 and 100 nucleotides long. The oligonucleotide can comprise at least or about 1, 2, 3, 4, 5, 6, 7, 8, 9, 10, 15, 20, 25, 30, 35, 40, 45, or 50 bases. The oligonucleotides can be from about 3 to about 5 bases, from about 1 to about 50 bases, from about 8 to about 12 bases, from about 15 to about 25 bases, from about 25 to about 35 bases, from about 35 to about 45 bases, or from about 45 to about 55 bases. The oligonucleotide (also referred to as “oligo”) can be any type of oligonucleotide (e.g., a primer). Oligonucleotides can comprise natural nucleotides, non-natural nucleotides, or combinations thereof.

The term “initiator” as used herein refers to a molecule that is used to initiate a polymerization reaction. Initiators for use in preparation of polymers are well known in the art. Representative initiators include, but are not limited to, initiators useful in atom transfer radical polymerization, living polymerization, the AIBN family of initiators and benzophenone initiators. An “initiator residue” is that portion of an initiator which becomes attached to a polymer through radical or other mechanisms. In some embodiments, initiator residues are attached to the terminal end(s) of the disclosed polymers. In the present disclosure, “initiator” and “initiator residue” may be interchangeable when describing initiator molecules left on a polymeric molecule.

The term “weight average molecular weight” as used herein refers to an average molecular weight for a polymer, composed of polymeric molecules with different polymer chain lengths or sizes, calculated from the weight fraction distribution of different sized molecules. Here is a procedure for determining average molecular weight utilizes the weight fraction of the polymer that is in each of several size fractions. The weight average molecular weight, M_{w}, is calculated as follows:

M_{w}={Sum[(Wᵢ)×(MW)ᵢ]}/{Sum Wᵢ}

where Wᵢ is the weight fraction of each size fraction and (MW)ᵢ is the mean molecular weight of the size fraction.

The concept of lab-on-chip involves the integration of many analytical operations on a miniaturized platform, for example, a micro-total-analysis-system (μTAS). D. J. Harrison et al., Anal. Chem. (1992) 64(17): 1926-32. These microchip systems include, for example, microfluidic systems, sensors, arrays or biochips, chemical synthesis on-chip, etc. Developments of the lab-on-chip concept in various analytical areas and novel materials have been reported. D. R. Reyes et al., Anal. Chem. (2002) 74(12): 2623-36; P. A. Auroux et al., Anal. Chem. (2002) 74(12): 2637-52.

The solid substrate for these microsystem chips, microfluidic chips, microchips, or biochips, are prepared from, for example, glass, silica, silicon, fused silica substrate materials, titanium oxide, aluminum oxide, indium tin oxide (ITO), and various polymeric materials, titanium, gold, other metals, or other suitable materials. Polymeric materials used include, for example, polydimethylsiloxane (PDMS), poly(methyl methacrylate) (PMMA), polycarbonate (PC), polystyrene (PS), polyethyleneterephthalate (PETG), polyvinylchloride (PVC) polyimide (PI), polyolefins, such as poly(methylpentene) (PMP) and Zeonor™, cyclic olefin copolymer such as Topas™, due to their lower cost, compatibility with biomolecules, optical transparency, number of replication strategies and disposability. H. Becker et al., Talanta (2002) 56(2): 267-87.

The term “substrate” as used herein refers to a material having a rigid, semi-rigid or gelatinous surface. Typical examples include solid substrate described above, including glass or suitable polymeric materials. In some embodiments of the present disclosure, at least one surface of the substrate will be substantially flat, although in some embodiments it may be desirable to physically separate synthesis regions for different polymers with, for example, wells, raised regions, etched trenches, or the like. In some embodiments, the substrate itself contains wells, trenches, flow through regions, etc. which form all or part of the synthesis regions. According to other embodiments, small beads may be provided on the surface, and compounds synthesized thereon optionally may be released upon completion of the synthesis. Examples of surfaces include flow cells, sequencing flow cells, flow channels, microfluidic channels, capillary tubes, piezoelectric surfaces, wells, microwells, microwell arrays, microarrays, chips, wafers, non-magnetic beads, magnetic beads, ferromagnetic beads, paramagnetic beads, superparamagnetic beads, and polymer gels. Substrates are well known in the art and are readily commercially available through vendors such as USPG, PPG Industries, AFG Industries and others. In certain embodiments, the substrates used in the present disclosure are those that are readily silanated, such as glass, quartz, fused silica and silicon wafers. D. Cuschin et al., Anal. Biochem. (1997) 250(2): 203-11.

As used herein, the singular form “a,” “an,” and “the” include plural references unless the context clearly dictates otherwise. For example, the term “a reagent” includes a plurality of reagents, including mixtures thereof.

The term “about” as used herein refers to +/−15%, 10%, 9%, 8%, 7%, 6%, 5%, 4%, 3%, 2%, or 1% of the designated amount.

The term “film” as used herein refers to a layer or coating having one or more constituents, applied in a generally uniform manner over the entire surface of a substrate, for example, by spin coating. For example, in accordance with an aspect of the present disclosure, a film is a solution, suspension, dispersion, emulsion, or other acceptable form of a chosen polymer. A film can include additional chemical reagents in combination with a film-forming polymer. Film-forming polymers are polymers, which after melting or dissolving in a compatible solvent can form a uniform film on a substrate. A polymeric film can be covalently bonded to the surface of a substrate via a chemical bond such as, for example, an amide bond, an ester bond, an alkylamino bond, and an alkoxy bond.

The term “reactive group” as used herein refers to a functional group that has reactivity for another target functional group such that the reactive group will react preferentially with the target functional group. For example, an amine-reactive group is a functional group, such as, for example, activated carbonyl compounds, including esters and amides, which preferentially react with the amine group.

The term “analyte” or “analyte molecule” as used herein refers to a compound or molecule which is the subject of an analysis. For example an analyte molecule may be of unknown structure and the analysis includes identification of the structure. Analyte molecules include any number of common molecules, including DNA, proteins, peptides and carbohydrates, organic and inorganic molecules, metals (including radioactive isotopes), and the like. Analytes include viruses, bacteria, plasmodium, fungi, as well as metals and bio-warfare, bio-hazard and chemical warfare materials.

The term “probe” as used herein refers to a molecule used for indirect identification of an analyte molecule. For example, a probe may carry sequence information which uniquely identifies an analyte molecule. Exemplary probes include carbohydrate, oligonucleotides and polypeptide, among others, with or without a linker.

The term “capture probe” as used herein refers to a molecule capable of interacting with an analyte molecule, for example by hydrogen bonding (e.g., DNA hybridization), sequestering, covalent bonding, ionic interactions, and the like. Exemplary capture probes include oligonucleotides which are capable of sequence specific binding (hybridization) with oligonucleotide probes or flaps, oligosaccharides (e.g. lectins) and proteins. In some embodiments capture probes comprise a fluorophore label. For example the capture probe may comprise a fluorophore label and an analyte molecule may comprise a quencher, and the presence of the analyte molecule is detected by an absence of a fluorescent signal from the capture probe (since the fluorescence is quenched upon interaction with the quencher). In related embodiments, the capture probe comprises a quencher. In these embodiments, the fluorescence of a fluorescently labeled analyte molecule is quenched upon capture by the capture probe. Exemplary probes include peptide, protein, glycosylated protein, glycoconjugate, aptomer, carbohydrate, polynucleotide, oligonucleotide and polypeptide.

The practice of the present disclosure employs, unless otherwise indicated, conventional techniques of organic chemistry, polymer technology, molecular biology (including recombinant nucleic acid techniques), cell biology, biochemistry, and immunology as would be understood by a person having ordinary skill in the art. Such conventional techniques include polymer array synthesis, hybridization, ligation, and detection of hybridization using a label. Specific illustrations of suitable techniques can be found in the examples disclosed hereinafter. However, other equivalent conventional procedures can be used. Such conventional techniques and descriptions can be found in standard laboratory manuals such as, for example, Genome Analysis: A Laboratory Manual Series (Vols. I-IV), Using Antibodies: A Laboratory Manual, Cells: A Laboratory Manual, PCR Primer A Laboratory Manual, and Molecular Cloning: A Laboratory Manual (all from Cold Spring Harbor Laboratory Press); Stryer, L. (1995) Biochemistry (4th Ed.) Freeman, N.Y.; Gait, “Oligonucleotide Synthesis: A Practical Approach” 1984, IRL Press, London; Nelson and Cox (2000), Lehninger, Principles of Biochemistry 3rd Ed., W.H. Freeman Pub., New York, N.Y.; and Berg et al. (2002) Biochemistry, 5th Ed., W.H. Freeman Pub., New York, N.Y., all of which are herein incorporated by reference in their entirety.

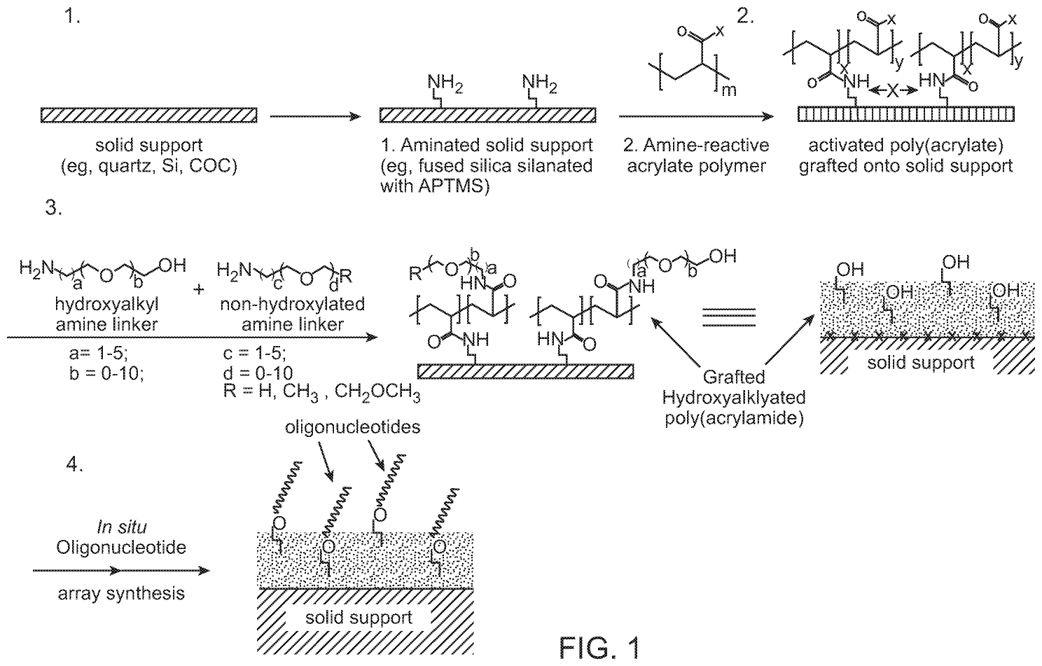

Turning now to FIG. 1, which shows an exemplary embodiments of the solid support and preparation thereof according to the present disclosure. In Step 1, a substrate is treated with reagents under conditions suitable to functionalize the surface of the substrate with covalently bonded amino groups. For example, glass substrates can be coated with aminoalkyltrialkoxysilanes. P. H. Maddox et al., J. Clin. Pathol. (1987) 40(10): 1256-7. Further, a variety of polymeric materials, for example, cyclo-olefin copolymer (COC), can be surface-aminated by ammonia plasma treatment. K. S. Siow et al., Plasma Process. Polym. (2006) 3: 392-418. Aminoalkyltrialkoxysilane can be aminoalkyltrimethoxysilane or aminoalkyltrmethoxysilane. The alkylene group in the aminoalkyl moiety of aminoalkyltrialkoxysilane can be C₂-C₁₀ alkylene, unsubstituted or substituted with 1 to 5 groups selected from C₁-C₅ alkyl, C₁-C₅ alkoxy, halide, and cyanide. Some carbons in the alkylene group can be replace with —O— or —N(R²⁰)—, wherein R²⁰ is a C₁-C₅ alkyl.

In addition, glass or polymeric materials can be coated with a thin film of crosslinked polyallyamine by radio frequency (RF) plasma deposition to provide amino groups on the surface of the substrates. T. M. Ko et al., J. Colloid Interface Sci. (1993), 156: 207-17; D. A. Puleo et al., Biomaterials (2002) 23(9): 2079-87; M. Taloulian et al. Plasma Processes and Polymers (2005) 2(1): 38-44. Surface treatments of the substrate to produce covalently bonded amino groups are not limited to the example described above or hereinafter. Other methods can be used to introduce amino groups on the surface of the substrate.

As shown in FIG. 1, the covalently bonded amino groups provide reactive centers for the next step. The amino groups are preferably primary amines, although reactive secondary amine groups may work as well. As shown in FIG. 1, the surface density of the reactive centers, for example, amino groups, can be controlled by the choice of the reagents used to introduce reactive centers, i.e., the amino groups. For example, when aminoalkyltrialkoxysilane is used to modify a glass surface, up to three surface hydroxyl groups originally on the glass surface are capped (or deactivated) by one new surface amino group, thereby reducing the surface density of available reaction centers (the total number of hydroxyl/amino groups).

In Step 2, an amine-reactive acrylate polymer with Formula II or an amine-reactive acrylate-co-acrylamide co-polymer with Formula III is applied to the substrate with surface amino group obtained in Step 1. These amine-reactive polymers react with the surface amino group to form amide bonds. As a result, a thin film of the acrylate polymer is bonded onto the surface. The thickness of the film can vary.

The amine-reactive acrylate polymer is a compound according to Formula II:

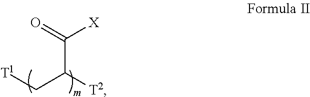

wherein X is an amine-reactive center independently selected from the group consisting of:

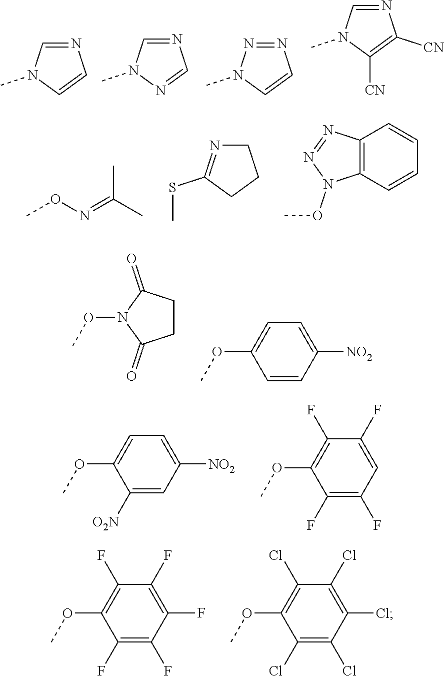

T¹ is absent, H, C₁-C₆ alkyl or a second initiator residue;
T² is absent, H, C₁-C₆ alkyl or a third initiator residue; and
m is an integer from 2 to 800.

The amine-reactive acrylate-co-acrylamide co-polymer is a compound according to Formula III:

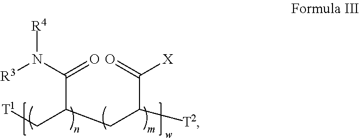

wherein X is an amine-reactive center, in each occurrence, independently selected from the group consisting of:

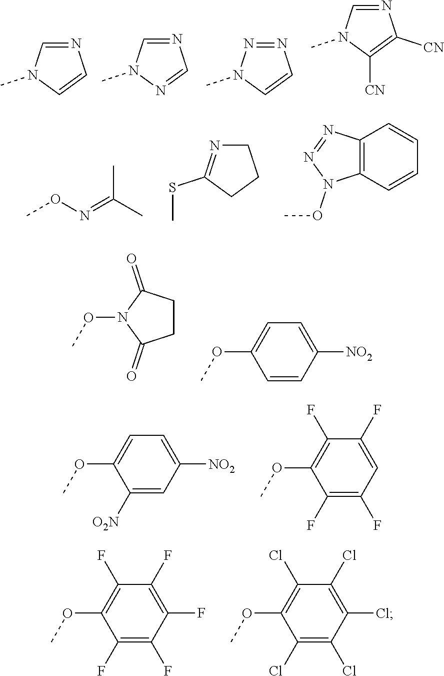

R³ and R⁴, in each occurrence, are independently H or —CH₃;
T¹ is absent, H, C₁-C₆ alkyl or a second initiator residue;
T² is absent, H, C₁-C₆ alkyl or a third initiator residue;
m is, in each occurrence, independently an integer from 1 to 20;
n is, in each occurrence, independently an integer from 1 to 20; and
w is an integer from 2 to 400.

The amine-active acrylate polymer coatings can comprise polymer molecules of a particular length or range of lengths. Polymer molecules can have a weight average molecular weight of from about 5,000 to about 200,000, from about 10,000 to about 180,000, from about 15,000 to about 160,000, from about 20,000 to about 140,000, from about 40,000 to about 100,000, or from about 60,000 to about 80,000. Polymer molecules can have a weight average molecular weight of about 5,000, about 10,000, about 15,000, about 20,000, about 25,000, about 30,000, about 35,000, about 40,000, about 45,000, about 50,000, about 55,000, about 60,000, about 65,000, about 70,000, about 75,000, about 80,000, about 85,000, about 90,000, about 95,000, about 100,000, about 105,000, about 110,000, about 115,000, about 120,000, about 125,000, about 130,000, about 135,000, about 140,000, about 145,000, about 150,000, about 155,000, about 160,000, about 165,000, about 170,000, about 175,000, about 180,000, about 185,000, about 190,000, about 195,000, about 200,000. Polymer molecules can have a length of at least 2, 3, 4, 5, 6, 7, 8, 9, 10, 11, 12, 13, 14, 15, 16, 17, 18, 19, 20, 25, 30, 35, 40, 45, 50, 55, 60, 65, 70, 75, 80, 85, 90, 95, 100, 110, 120, 130, 140, 150, 160, 170, 180, 190, 200, 250, 300, 350, 400, 450, 500, 550, 600, 650, 700, 750, 800 backbone atoms or molecules (e.g., carbons). Polymer molecules can have a length of at least 2, 3, 4, 5, 6, 7, 8, 9, 10, 11, 12, 13, 14, 15, 16, 17, 18, 19, 20, 21, 22, 23, 24, 25, 30, 35, 40, 45, 50, 55, 60, 65, 70, 75, 80, 85, 90, 95, 100, 110, 120, 130, 140, 150, 160, 170, 180, 190, 200, 250, 300, 350, 400, 450, 500, 550, 600, 650, 700, 750 monomer units (e.g., acrylate and/or acrylamide molecules).

The amine-reactive X group reacts with the surface amino group to form an amide bond between the polymer and the surface of the substrate. In one embodiment, the surface density of the surface amino group is less than that of the amine-reactive X groups within the polymer such that after reacting with the surface amino group, only a first fraction of the X groups is consumed to form the amide bond and a second fraction of the X groups is left intact on the surface-bonded co-polymer. The ratio between the first and second fraction of the X groups may be x:y, as shown in FIG. 1. The ratio between the first and second fractions of the X groups can be about 1:20, about 1:19, about 1:18, about 1:17, about 1:16, about 1:15, about 1:14, about 1:13, about 1:12, about 1:11, about 1:10, about 1:9, about 1:8, about 1:7, about 1:6, about 1:5, about 1:4, about 1:3, about 1:2, about 1:1, about 2:1, about 3:1, about 4:1, about 5:1, about 6:1, about 7:1; about 8:1, about 9:1, about 10:1, about 11:1, about 12:1, about 13:1, about 14:1, about 15:1, about 16:1, about 17:1, about 18:1, about 19:1, and about 20:1. The remaining amine-reactive X groups (the second fraction of the X groups) can be processed further in Step 3. It should be noted that although both surface amino groups in FIG. 1 are shown to be acylated (formed an amide bond with a polymer), due to reasons such as the size of the amine-reactive polymer or steric hindrance or reactivity variance, some surface amino groups may not form the amide bond shown in Step 2. An amine-reactive acrylate-co-acrylamide co-polymer of Formula III can form amide bonds similarly to what is shown in Step 2.

In Step 3, the surface-bonded polymer film with remaining amine-reactive X group is further exposed to a large molar excess of a hydroxyalkyl-functionalized amine, preferably a primary amine due to reactivity concerns. The hydroxyalkyl group can become an anchor to introduce various Capture Probes. The amino group of the hydroxyalkyl-functionalized amine reacts with the second fraction of the X groups, which are amine reactive, to afford a hydroxyalkylated poly (acrylamide) film on the surface of the substrate. For example, the hydroxyalkyl-functionalized amine can be a compound of Formula IV:

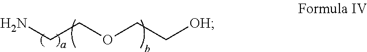

wherein a is an integer from 1 to 5; and
b is an integer from 0 to 10.

Alternatively, as a means to control the concentration or density of surface available hydroxyalkyl groups within the film, a non-functionalized amine, for example, ammonia or an alkyl amine or an alkoxyalkylamine, can be added in varying proportions with respect to the hydroxyalkyl-functionalized amine as a competitor molecule in this amide-formation reaction. For example, the non-functionalized amine can be a compound of Formula V:

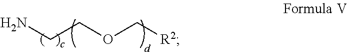

wherein R² is independently H, —CH₃, or —CH₂OCH₃;
c is an integer from 1 to 5; and
d is an integer from 0 to 10.

It should be noted that the choice of the hydroxyalkyl-functionalized amine and non-functionalized amine are not limited to the examples shown above or hereinafter. Other amines may be used as well. Thus, the term “hydroxyalkyl-functionalized amine” as used herein refers to a compound comprises a reactive amine on one end and a hydroxyl group on the other end with an alkylene linker in-between the amine group and the hydroxyl group. The alkylene linker can be C₂-C₁₀ alkylene, unsubstituted or substituted with 1 to 5 groups selected from the group consisting of C₁-C₅ alkyl, C₁-C₅ alkoxy, halide, and cyanide. Some carbons in the alkylene linker can be replace with —O— or —N(R²⁰)—, wherein R²⁰ is a C₁-C₅ alkyl. After Step 3, the surface of the substrate comprises grafted hydroxyalkylated poly(acrylamide) ready to connect with Capture Probes.

In Step 4, the hydroxyalkylated poly(acrylamide) coated substrate is employed directly in in situ oligonucleotide array synthesis using inkjet or photolithographic printing technologies via the free hydroxyl group. The result is that the oligonucleotides are covalently attached to a poly(acrylamide) backbone. For example, standard oligonucleotide probe synthesis can be conducted on the free hydroxyl group of the hydroxyalkylated poly(acrylamide) to synthesize oligonucleotide sequences.

In addition, other biomolecules can be coupled to the polymer coatings described in the present disclosure to afford biomolecule arrays. The biomolecules can comprise antibodies. The biomolecules can comprise proteins. The biomolecules can comprise peptides. The biomolecules can comprise enzymes. The biomolecules can comprise aptamers. The biomolecules can comprise oligonucleotides.

Oligonucleotides can be coupled to the polymer coatings described in the present disclosure. The oligonucleotides can comprise primers. The oligonucleotides can comprise cleavable linkages. Cleavable linkages can be enzymatically cleavable. The oligonucleotides can comprise at least 1, 2, 3, 4, 5, 6, 7, 8, 9, 10, 11, 12, 13, 14, 15, 16, 17, 18, 19, 20, 25, 30, 35, 40, 45, 50, 55, or 60 bases. The oligonucleotides can vary in length, such as from 3 to 5 bases, from 1 to 50 bases, from 6 to 12 bases, from 8 to 12 bases, from 15 to 25 bases, from 25 to 35 bases, from 35 to 45 bases, or from 45 to 55 bases. The individual oligonucleotides coupled to the coatings can differ from each other in length or composition.

Biomolecules (e.g., oligonucleotides) can be incorporated into the polymer coatings in a controlled manner, with particular biomolecules located at particular regions of the polymer coatings. Biomolecules can be incorporated into the polymer coatings at random, with particular biomolecules randomly distributed throughout the polymer coatings.

In some instances a composition of the invention comprises a surface, a polyacrylamide coating covalently bonded to said surface; and at least one oligonucleotide coupled to said polyacrylamide coating. In other instances, the surface includes at least 1, 10, 100, 10,000, 100,000, 1,000,000, 10,000,000, 100,000,000, or 1,000,000,000 oligonucleotides coupled to the polyacrylamide coating.

The polymer coatings described in this disclosure can be robust. The robustness of the polymer coatings can be exhibited by the durability, the resistance to degradation, or the level of attachment of the coating after being subjected to certain conditions. The robustness of the polymer coatings can be exhibited by the number or percentage of biomolecules (e.g., oligonucleotides) molecules coupled to the polymer coating which remain coupled to the polymer coating after being subjected to certain conditions. Conditions can include but are not limited to duration of time, a temperature or set of temperatures, presence of chemicals (e.g., acids, bases, reducing agents, oxidizing agents), mechanical forces (e.g. stress, strain, vibrations, high pressures, vacuums), combinations of conditions, or repeated cycles of conditions or combinations of conditions (e.g. reaction cycles comprising temperatures and use of chemicals). Durations of time can comprise at least 1, 2, 3, 4, 5, 6, 7, 8, 9, 10, 20, 30, 40, or 50 minutes, at least 1, 2, 3, 4, 5, 6, 7, 8, 9, 10, 11, 12, 13, 14, 15, 16, 17, 18, 19, 20, 21, 22, or 23 hours, at least 1, 2, 3, 4, 5, 6, 7, 8, 9, 10, 11, 12, or 13 days, or at least 2, 3, 4, 5, 6, 7, 8, 9, 10, 12, 14, 16, 18, 20, 22, 24, 26, 28, 30, 40, 50, or 60 weeks. Temperatures can comprise at least 0, 5, 10, 15, 20, 25, 30, 35, 40, 45, 50, 55, 60, 65, 70, 75, 80, 85, 90, 95, or 100° C. Temperatures can comprise at most 0, 5, 10, 15, 20, 25, 30, 35, 40, 45, 50, 55, 60, 65, 70, 75, 80, 85, 90, 95, or 100° C. Chemicals can comprise strong acids, weak acids, strong bases, weak bases, strong oxidizers, weak oxidizers, strong reducers, weak reducers, enzymes, monomers, polymers, buffers, solvents, or other reagents. Cycles of conditions can comprise at least 1, 2, 3, 4, 5, 6, 7, 8, 9, 10, 11, 12, 13, 14, 15, 16, 17, 18, 19, 20, 21, 22, 23, 24, 25, 26, 27, 28, 29, 30, 31, 32, 33, 34, 35, 36, 37, 38, 39, 40, 41, 42, 43, 44, 45, 46, 47, 48, 49, 50, 55, 60, 65, 70, 75, 80, 85, 90, 95, 100, 125, 150, 175, 200, 250, 300, 350, 400, 450, 500, 600, 700, 800, 900, 1000, 2000, 3000, 4000, 5000, 6000, 7000, 8000, 9000, or 10,000 cycles. In some embodiments, the polymer coatings herein are used to perform at least 10, 20, 30, 40, 50, 60, 70, 80, 90, 100, 200, 300, 400, 500, 600, 700, 800, 900, or 1000 cycles of conditions, and wherein at least 50, 60, 70, 80, 90, 91, 92, 93, 94, 95, 96, 97, 98, 99, 99.5 or 99.9% the polymer chains remain completely intact and bonded to said surface after the cycles.

### Example 1: Preparation of Aminated Substrate

Fused silica substrates (ESCO) were cleaned by soaking/agitating in Nanostrip (Cyantek, Fremont, Calif.) for 4 hours. Substrates were then rinsed thoroughly with deionized water and spin-dried for 5 minutes under a stream of nitrogen at 35° C. The freshly cleaned substrates were stored under nitrogen and silanated within 24 hours. The substrates were silanated with 5% (3-aminopropyl)-trimethoxysilane (APTMS, Gelest, 2% in 95:5 ethanol-water); rinsed thoroughly with ethanol and water, and then spin-rinse dried to afford the APTMS-aminated silica substrates.

### Example 2: Application of Amine-Reactive Acrylate Polymer Thin Film

The APTMS-aminated silica substrates obtained in Experiment 1 were immersed in a solution of poly(pentafluorophenylacrylate) (PFPA, prepared as previously described; also see R. M. Arnold et al., Chem. Commun. (2014) 50(40): 5307-9; L. Q. Xu et al., Polym. Chem. (2012) 3: 920-7) at a concentration of 10 mg/ml in dry THF containing diisopropylethylamine (10 mg/ml) in a closed polypropylene container. The container was agitated on an orbital shaker for 18-24 hr. The substrates were then rinsed thoroughly with acetone and isopropanol, then blow-dried and stored in a desiccator to afford the substrates coated with the activated acrylate polymer thin film.

### Experiment 3: Hydroxyalkylation of the Acrylamide Polymer Thin Film

The substrates coated with the activated acrylate polymer were immersed in a bath containing ethanolamine (10% w/v) in ethanol in a closed polypropylene container, and then agitated on an orbital shaker for 8-16 hr to provide the hydroxyalkylated acrylamide polymeric film on the substrates. Optionally, to quench any unreacted acrylate esters remaining on the film of the substrates, the substrates were then transferred into a bath of 2.0 M ammonia in ethanol and agitated on orbital shaker for an additional 2-4 hr, rinsed thoroughly with ethanol and water, and blow-dried. Such treatment with non-functionalized amine or ammonia quenches unreacted acrylate activated esters.

### Experiment 4: In Situ Oligonucleotide Probe Array Synthesis

A test oligonucleotide probe sequence was synthesized on the hydroxyalkylated acrylamide substrates in a checkerboard mask pattern using photolithographic synthesis with 5′-photoprotected nucleoside phosphoramidite monomers (G. H. McGall et al., Methods Molec. Biol. (2001) 170: 71-101; G. H. McGall et al., J Am. Chem. Soc. (1997) 119(22): 5081-90). The test sequence was 5′-GGCTGAGTATGTGGTCTAT-3′-(HEG), with the 3′ end attached via a hexaethylene glycol (HEG) spacer to the hydroxyalkylated surface via phosphodiester linkage. After the synthesis, the array was incubated in a mixture of 1:1 ethylenediamine-water at room temperature for 7 hrs, rinsed with water, then blow-dried.

### Hybridization Experiment 1

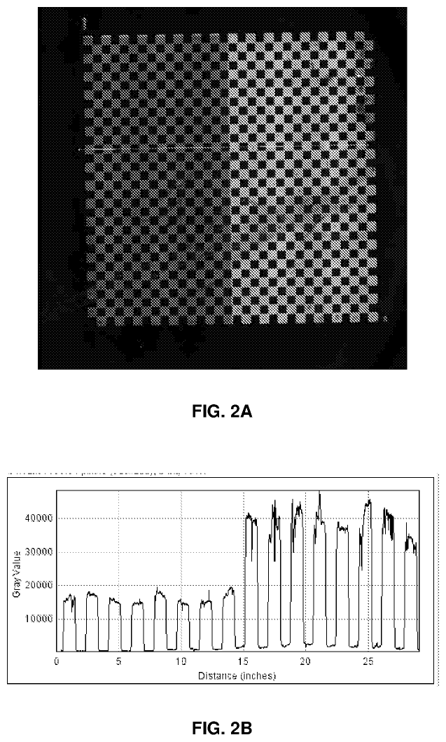

For hybridization measurements the array was incubated with a 5′-Cy3-labeled complementary 20-mer target oligonucleotide at a concentration of 100 nM in 4×SSC buffer at 50° C. for 30 minutes, then washed with 4×SSC buffer at room temp. Fluorescence images were taken on a Keyence fluorescence microscope (Cy3 filter set, 40× magnification, 4 sec acquisition time). The acquired image is shown in FIG. 2.

### Hybridization Experiment 2

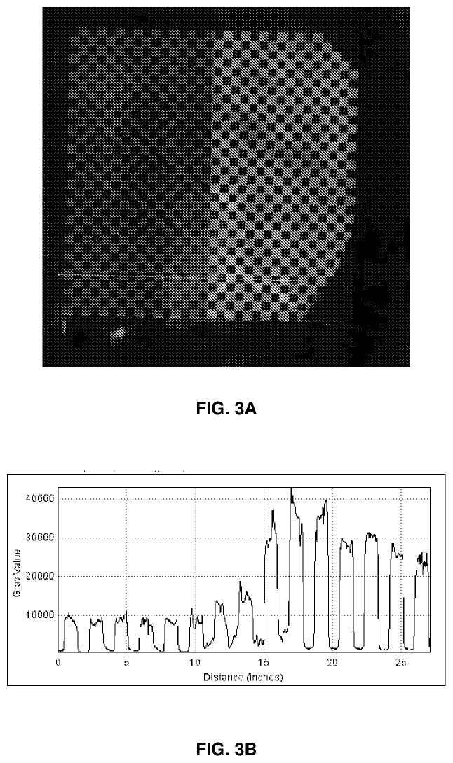

The array was then rinsed with water, incubated in aqueous 1:1 ammonia-methylamine at room temperature for 2 hrs, water-rinsed & dried, re-hybridized with the Cy3-labeled target and imaged again under the same conditions as above. The acquired image is shown in FIG. 3.

### Hybridization Experiment 3

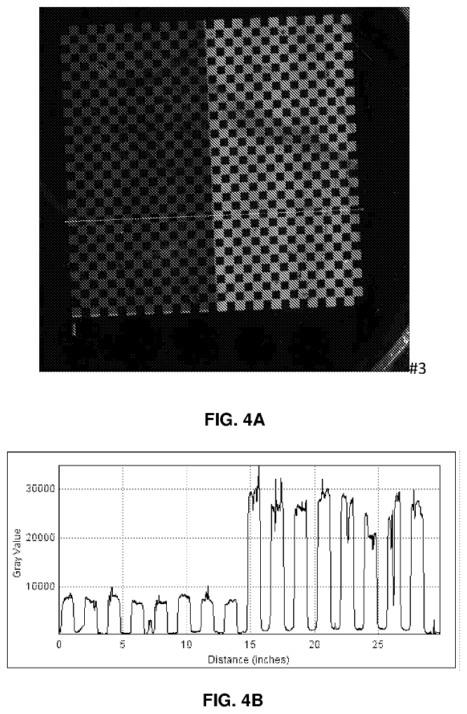

The array was then rinsed with water, incubated in aqueous 1:1 ammonia-methylamine at 65° C. for 1 hr, water-rinsed & dried, re-hybridized with the Cy3-labeled target and imaged again under the same conditions as above. The acquired image is shown in FIG. 4.

### Hybridization Experiment 4

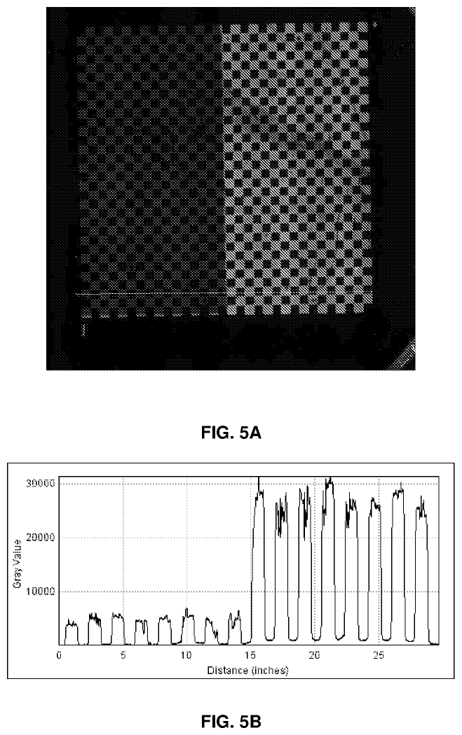

The array was then rinsed with water, incubated in aqueous 1:1 ethylenediamine at 45° C. for 18 hr, water-rinsed & dried, re-hybridized with the Cy3-labeled target and imaged again under the same conditions as above. The acquired image is shown in FIG. 5.

### Advantages

Comparing images in FIGS. 2-5 demonstrated that the polymeric film of the present disclosure exhibited the following characteristics:
uniform, highly wettable surface
uniform fluorescence hybridization low background image;
very high stability in aqueous base solutions at elevated temperatures;
compatible with oligonucleotide probe array synthesis processes;
hybridization signal intensity equivalent to standard hydroxyalkylsilanated substrates;
compatible with “on-chip” ligation and polymerase extension; and
excellent batch-to-batch consistency.

While preferred embodiments of the present invention have been shown and described herein, it will be obvious to those skilled in the art that such embodiments are provided by way of example only. Numerous variations, changes, and substitutions will now occur to those skilled in the art without departing from the invention. It should be understood that various alternatives to the embodiments of the invention described herein may be employed in practicing the invention. It is intended that the following claims define the scope of the invention and that methods and structures within the scope of these claims and their equivalents be covered thereby.

What is claimed is:

1. A solid support, comprising covalently surface-bonded polymers comprising a compound of Formula I: 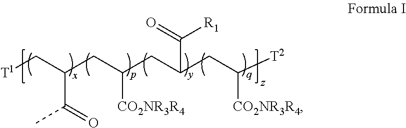
wherein R¹ is independently selected from the group comprising: 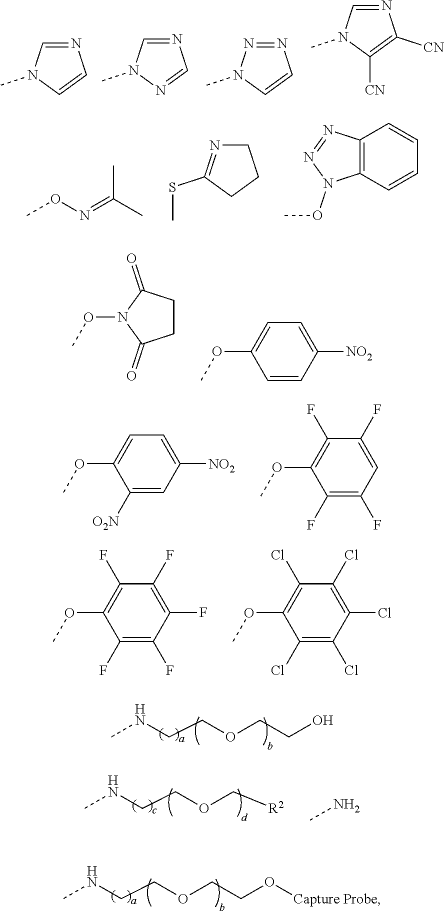
with the proviso that at least one R¹ is 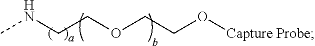
T¹ is absent, H, C₁-C₆ alkyl, or a first initiator residue;
T² is absent, H, C₁-C₆ alkyl or a second initiator residue;
R² is independently H, —CH₃, or —CH₂OCH₃;
R³ and R⁴, in each occurrence, are independently H or —CH₃;
Capture Probe comprises at least one molecule selected from the group consisting of peptide, protein, glycosylated protein, glycoconjugate, aptomer, carbohydrate, polynucleotide, oligonucleotide and polypeptide;
x is independently an integer from 1 to 20;
y is independently an integer from 1 to 20;
z is independently an integer from 2 to 200;
p is independently an integer from 0 to 20;
q is independently an integer from 0 to 20;
a is an integer from 1 to 5;
b is an integer from 0 to 10;
c is an integer from 1 to 5; and
d is an integer from 0 to 10.

2. The solid support of claim 1, further comprising a surface comprising a plurality of amino groups covalently bonded to the surface, thereby allowing the compound of Formula I to covalently bond to at least a fraction of the plurality of the amino groups via an amide bond.

3. The solid support of claim 1, wherein p is independently an integer from 1 to 20 and q is independently an integer from 1 to 20.

4. The solid support of claim 1, wherein R¹ is independently selected from the group consisting of:

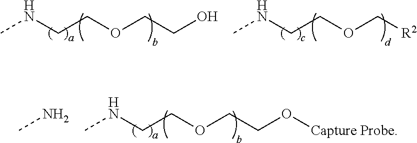

5. The solid support of claim 4, wherein the Capture Probe is an oligonucleotide.

6. The solid support of claim 6, wherein the Capture Probe is DNA.

7. The solid support of claim 2, wherein the surface is glass or a polymeric substrate.

8. The solid support of claim 7, wherein the polymeric substrate is at least one selected from the group consisting of an acrylnitrile-butadien-styrene, a cyclo-olefin-polymer, a cyclo-olefin copolymer, a polymethylene-methacrylate, a polycarbonate, a polystyrole, a polypropylene, a polyvinylchloride, a polyamide, a polyethylene, a polyethylene-terephthalate, a polytetrafluoro-ethylene, a polyoxymethylene, a thermoplastic elastomer, a thermoplastic polyurethane, a polyimide, a polyether-ether-ketone, a polylactic acid, and a polymethylpentene.

9. A solid support, comprising covalently surface-bonded polymers comprising a compound of Formula I: 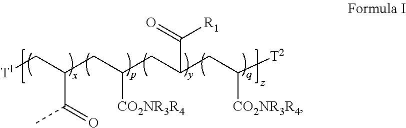
wherein R¹ is independently selected from the group consisting of: 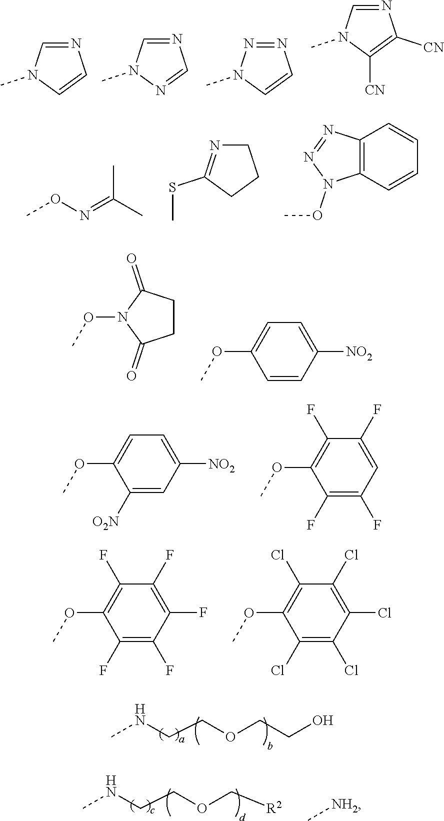
T¹ is absent, H, C₁-C₆ alkyl, or a first initiator residue;
T² is absent, H, C₁-C₆ alkyl or a second initiator residue;
R² is independently H, —CH₃, or —CH₂OCH₃;
R³ and R⁴, in each occurrence, are independently H or —CH₃;
x is independently an integer from 1 to 20;
y is independently an integer from 1 to 20;
z is independently an integer from 2 to 200;
p is independently an integer from 0 to 20;
q is independently an integer from 0 to 20;
a is an integer from 1 to 5;
b is an integer from 0 to 10;
c is an integer from 1 to 5; and
d is an integer from 0 to 10.

10. The solid support of claim 9, further comprising a surface comprising a plurality of amino groups covalently bonded to the surface, thereby allowing the compound of Formula I to covalently bond to at least a fraction of the plurality of the amino groups via an amide bond.

11. The solid support of claim 9, wherein p is independently an integer from 1 to 20 and q is independently an integer from 1 to 20.

12. The solid support of claim 9, wherein R¹ is independently selected from the group consisting of:

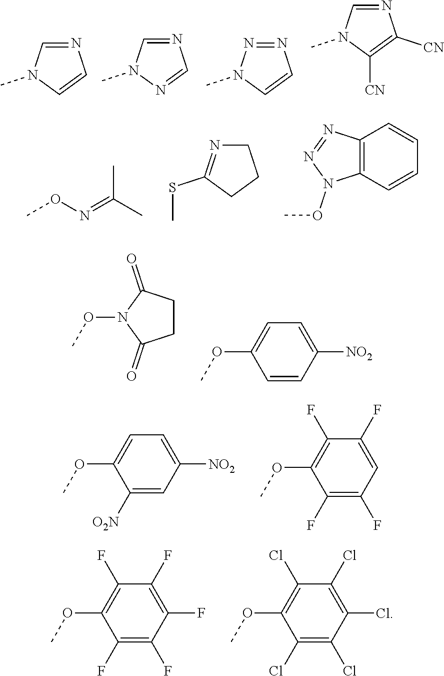

13. The solid support of claim 9, wherein R¹ is

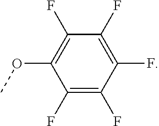

14. The solid support of claim 9, wherein R¹ is independently selected from the group consisting of:

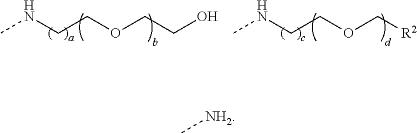

15. The solid support of claim 10, wherein the surface is glass or a polymeric substrate.

16. The solid support of claim 15, wherein the polymeric substrate is at least one selected from the group consisting of an acrylnitrile-butadien-styrene, a cyclo-olefin-polymer, a cyclo-olefin copolymer, a polymethylene-methacrylate, a polycarbonate, a polystyrole, a polypropylene, a polyvinylchloride, a polyamide, a polyethylene, a polyethylene-terephthalate, a polytetrafluoro-ethylene, a polyoxymethylene, a thermoplastic elastomer, a thermoplastic polyurethane, a polyimide, a polyether-ether-ketone, a polylactic acid, and a polymethylpentene.

17. A method of derivatizing a surface of a substrate, comprising:
(a) providing a substrate having a surface comprising a plurality of first amino groups;
(b) reacting a first set of a plurality of reactive groups of a first reagent with a set of the plurality of the first amino groups, thereby forming a covalently surface-bonded film; and
(c) reacting a second set of the plurality of the reactive groups of the first reagent with a second reagent comprising a second amino group and a hydroxyalkyl-functionalized group, thereby forming a hydroxyalkylated surface-bonded film.

18. The method of claim 17, wherein the first amino group in (a) is a primary amine.

19. The method of claim 17, further comprising, prior to (a), treating the surface of the substrate with aminoalkyltrialkoxysilanes, ammonia plasma, or RF plasma deposition.

20. The method of claim 17, wherein the first reagent in (b) is an amine-reactive acrylate polymer or an amine-reactive acrylate-co-acrylamide co-polymer.

21. The method of claim 20, wherein the amine-reactive acrylate polymer is a compound according to Formula II: 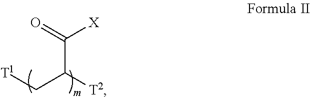
wherein X is an amine-reactive center independently selected from the group consisting of: 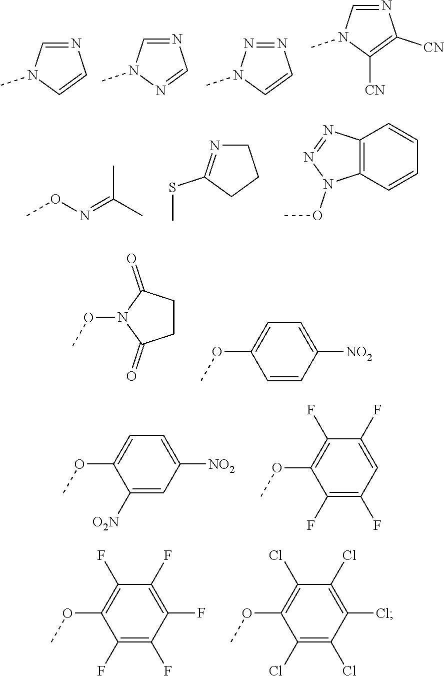
T¹ is absent, H, C₁-C₆ alkyl or a first initiator residue;
T² is absent, H, C₁-C₆ alkyl or a second initiator residue; and
m is an integer from 2 to 800.

22. The method of claim 20, wherein the acrylate-co-acrylamide co-polymer is a compound according to Formula III: 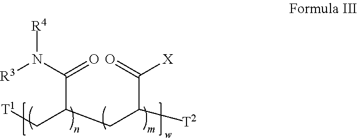
wherein X is an amine-reactive center, in each occurrence, independently selected from the group consisting of: 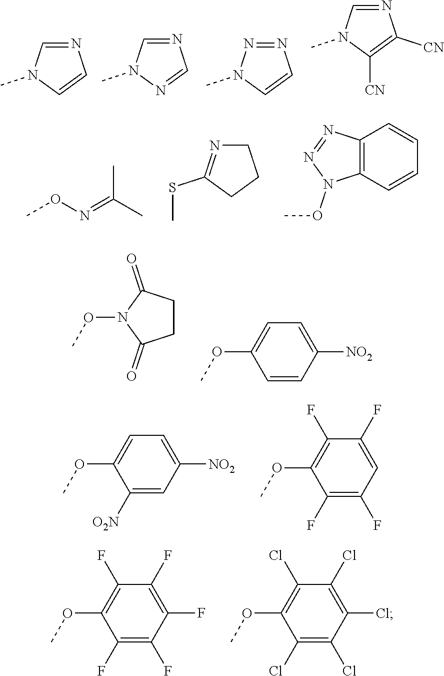
R³ and R⁴, in each occurrence, are independently H or —CH₃;
T¹ is absent, H, C₁-C₆ alkyl or a first initiator residue;
T² is absent, H, C₁-C₆ alkyl or a second initiator residue;
m is, in each occurrence, independently an integer from 1 to 20;
n is, in each occurrence, independently an integer from 1 to 20; and
w is an integer from 2 to 400.

23. The method of claim 17, wherein the reactive group is —C(O)X and X is independently selected from the group consisting of:

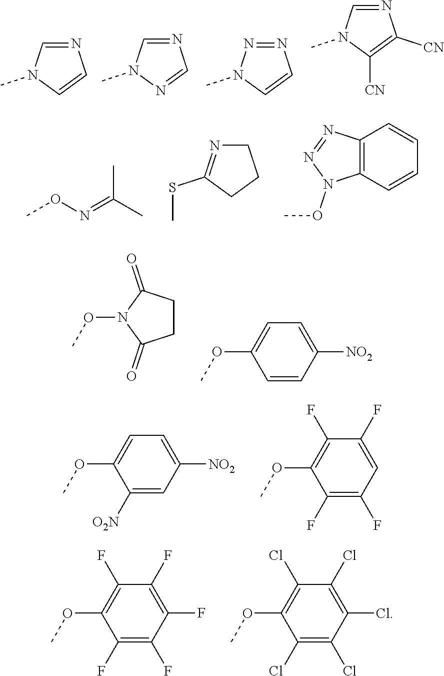

24. The method of claim 17, further comprising in (c) reacting a third set of the plurality of the reactive groups with a third reagent comprising a third amino group, but not a hydroxyl group.

25. The method of claim 17 further comprising (d) reacting the hydroxyalkylated surface-bonded film with a fourth reagent, thereby synthesizing an oligonucleotide array.

26. The method of claim 25, wherein the synthesizing in (d) comprises inkjet synthesis or photolithographic synthesis.

27. The method of claim 25, wherein the reacting in (d) comprises alkylation of the hydroxyalkyl group with an oligonucleotide reagent.

28. The method of claim 17, wherein the first reagent has a molecular weight of from about 5,000 to about 200,000.
